(19) United States
(12) Patent Application Publication
(10) Pub. No.: US 2005/0193138 A1
(43) Pub. Date: Sep. 1, 2005

(54) Storage medium storing multimedia data, and method and apparatus for reproducing the multimedia data

(75) Inventor: Hae-kwang Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-Si (KR)

(21) Appl. No.: 11/064,859

(22) Filed: Feb. 25, 2005

(30) Foreign Application Priority Data
Feb. 27, 2004 (KR) 2004-13580

(51) Int. Cl. G06F 15/16

(52) U.S. Cl. 709/231; 709/203

(57) ABSTRACT

A storage medium storing multimedia data, and a method and apparatus for reproducing the multimedia data. The method of reproducing multimedia data in a terminal, includes: receiving contents additional information regarding a data structure of at least one of plural media streams constituting of the multimedia data; requesting storage data recorded on a local storage medium according to the contents additional information, and receiving and storing the storage data; requesting streaming data over the network according to the contents additional information, and receiving the streaming data; and using the storage data and the streaming data to reconstruct and reproduce an original media stream, according to the contents additional information.

### CROSS-REFERENCE TO RELATED APPLICATION

This application claims the priority of Korean Patent Application No. 2004-13580, filed on Feb. 27, 2004, in the Korean Intellectual Property Office, the disclosure of which is incorporated herein by reference.

### BACKGROUND OF THE INVENTION

1. Field of the Invention

The present invention relates to encoding/decoding of multimedia content, and more particularly, to a storage medium storing multimedia data structured for streaming, and a method and apparatus for reproducing the multimedia data.

2. Description of Related Art

Multimedia data, such as video data, audio data, computer animation data, or any combination thereof, is reproduced in synchronicity with reference to time synchs within and between each type of data. For example, time sync information is included in each of audio data and video data in order for them to be reproduced together in synchronization, and information is included in each of them indicating when they should be output. By streaming such multimedia data over a wired/wireless network, e.g., the Internet, educational, entertainment, or other content can be provided.

Streaming services are limited by certain network conditions, such as network jitter, channel bandwidth, transmission delay, packet loss ratio, bit error ratio, etc., and terminal settings, such as data throughput, memory capacity, etc.

To overcome these limitations, a streaming service can be provided by combining conventional downloading and streaming technologies. In this case, however, all of the streaming contents including download data and streaming data are transferred under the control of a streaming server to the terminal at a user's request, thereby causing a delay in reproducing the download data. Also, both the download data and the streaming data are transmitted from the streaming server via a network, and thus a burden on the network is increased.

### BRIEF SUMMARY

An aspect of the present invention provides a storage medium storing multimedia data, and a method and apparatus for reproducing the multimedia data, in which a multimedia streaming service is provided by combining data stored in the storage medium in advance and streaming data received by the terminal from a streaming server by utilizing additional information about the content.

According to an aspect of the present invention, there is provided a storage medium storing multimedia data, the multimedia data including: at least one media stream that includes information about streaming data providable over a network, and storage data readable from a local storage medium by a terminal and stored in the terminal; and additional information that includes information about how to combine the streaming data and the storage data.

The streaming data may be provided by a server connected through the network and the storage data is stored in the local storage medium accessed by the terminal.

The additional information may be originally recorded on the local storage medium, and include information about a name of a file, a location, a data size, and/or meta-information.

The media stream may include contents additional information used to combine a first sub-stream including the streaming data and a second sub-stream including the storage data so as to reconstruct the media stream.

The contents additional information may include: information about the number of media streams constituting multimedia data; and stream additional information regarding attributes of the media streams.

The stream additional information may include: information about identifiers of the first sub-stream and the second sub-stream; information about whether the first sub-stream or the second sub-stream is storage data or streaming data; and information about a structure of the storage data and the streaming data.

According to another aspect of the present invention, there is provided a method of reproducing multimedia data in a terminal, including: receiving contents additional information regarding a data structure of at least one of plural media streams constituting multimedia data; requesting storage data recorded on a local storage medium according to the contents additional information, and receiving and storing the storage data; requesting streaming data over the network according to the contents additional information, and receiving the streaming data; and using the storage data and the streaming data to reconstruct and reproduce an original media stream, according to the contents additional information.

According to a still another aspect of the present invention, there is provided aterminal comprising: a storage sub-stream buffer that receives storage sub-streams from a local storage medium; a streaming sub-stream buffer that receives streaming sub-streams from the streaming server over a network; a decoder that combines the storage sub-streams and the streaming sub-streams to make a media stream and decode the media stream; and a renderer that reproduces decoded media streams according to time syncs between the decoded media streams.

The terminal may include a storage sub-stream storage unit that stores the storage sub-streams and the additional information about the storage sub-streams.

The terminal may include a de-multiplexer that generates a plurality of streaming sub-streams from streaming data received from the streaming server.

According to another embodiment of the present invention, there is provided a reproducing apparatus, including: a first de-multiplexer which splits streaming sub-streams into plural sub-streams; streaming sub-stream buffers which store the split sub-streams; a second de-multplexer which divides storage sub-streams into plural storage sub-streams; storage sub-stream buffers which store the divided storage streams; pre-decoding buffers for each type of stream; and media stream decoders which combine the respective storage sub-streams and the streaming sub-streams to yield media streams and which decode the media streams.

According to another embodiment of the present invention, there is provided a method of providing streaming service from a server to a reproducing apparatus, the method including: sending a content reproduction command to a DVD player when a content reproduction command in input by a user; reading additional information from a DVD in the DVD player upon receipt of the content reproduction command; analyzing the additional information and requesting a streaming service from a streaming server; receiving streaming data from the streaming server; requesting that the DVD player transmit storage sub-streams; receiving the storage sub-streams and storing the received storage sub-streams; receiving real-time streaming sub-streams from the server; and combining the stored storage sub-streams and the real-time streaming sub-streams to reproduce content according to the additional information.

According to other aspects of the present invention, there are provided computer-readable storage media encoded with processing instructions for causing a processor to perform the above-mentioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 shows a multimedia data structure according to an embodiment of the present invention;

FIG. 2 shows media streams including storage segments and streaming segments;

FIG. 3 shows storage sub-streams and streaming sub-streams collected from the media streams of FIG. 2;

FIG. 4 shows an example of the contents of the additional information of FIG. 3;

FIG. 5 is a block diagram illustrating a streaming service provided from a server to a reproducing apparatus according to an embodiment of the present invention;

FIG. 6 is a block diagram of a reproducing apparatus according to an embodiment of the present invention; and

FIG. 7 is an example of additional information that is compatible with the MPEG-4 standard.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

FIG. 1 shows a multimedia data structure according to an embodiment of the present invention.

Multimedia content may include various data, e.g., video, audio, text, etc., each of which can be referred to as a media stream. FIG. 1 shows an example of multimedia content including 3 media streams A-C 110, 120, and 130, respectively, each of which contains intra-media time sync information for achieving internal synchronization and inter-media time sync information for synchronizing with other media streams. The intra-media time synch information and the inter-media time synch information are generated by using a system reference clock.

The time synch information will now be described in detail. In the case of an MPEG-4 system, a reproduction starting time of each media stream is recorded at ‘startTime’ of node information in binary format or scene description (BIFS). Information on a location of each media stream is also recorded in the BIFS. A media stream is divided into access units, which are basic units of decoding and are carried in a synchronization layer packet (SL Packet). Information about composition time stamps (CTS), decoder time stamps (DTS), and object clock references (OCR) are recorded in a header of the SL Packet. By using the information about CTS, DTS, and OCR, time synchronization within a media stream and between media streams can be achieved.

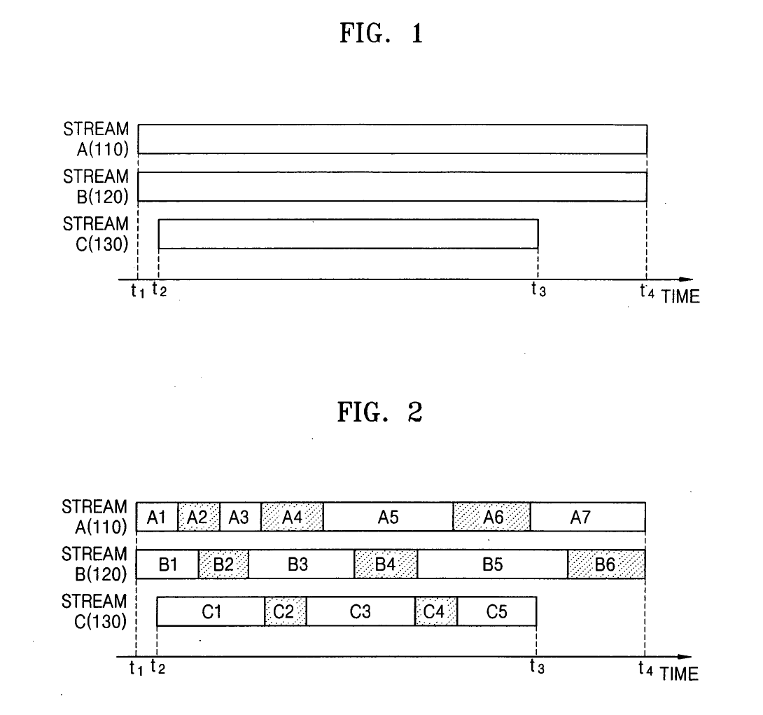

FIG. 2 shows media streams including storage segments and streaming segments.

Referring to FIG. 2, each of media streams 110, 120, and 130 includes storage segments (shaded portions of FIG. 2) and streaming segments. The storage segments, which are irrelevant to a streaming server, are stored in a storage unit of a terminal before the streaming server starts streaming. The streaming segments are transferred to the terminal in real-time by the streaming server's streaming.

As an example of obtaining and storing the storage segments in the storage unit of the terminal, the terminal may be connected to a DVD player and receive the storage segments from a DVD including the storage streams and additional information provided by a content service provider. In the DVD, there are 3 separate areas: a storage data area in which the storage data is recorded, a streaming data area in which streaming data information to be received from the streaming server is recorded, and an additional information area for additional information indicating how to combine the storage data and the streaming data.

How the streaming segments and the storage segments are divided is determined by the content provider according to a data transfer ratio of the network and input buffer capacity of the terminal. For example, in order to avoid input buffer overflow or underflow, a part of the input buffer can be first assigned to the streaming segments, and the remaining parts of the input buffer assigned to the storage segments. In the case of an MPEG-4 system, the storage segments and the streaming segments are comprised of a plurality of access units. Alternatively, in the case of scalable media stream, data of a base layer corresponds to the storage data and data of an enhancement layer corresponds to the streaming data. Generally, only the data of the base layer is provided to a user, but the data of the enhancement layer may also be provided for improved quality.

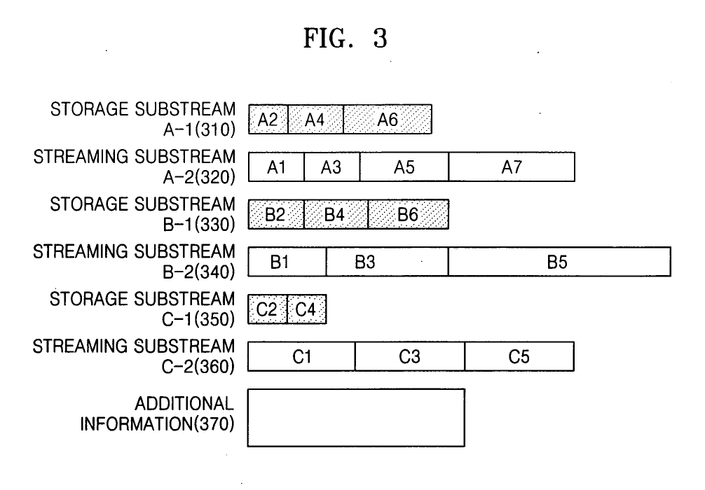

FIG. 3 shows storage sub-streams and streaming sub-steams collected from the media streams of FIG. 2.

Referring to FIG. 3, stream A of FIG. 2 is divided into a storage sub-stream A-1 310 and a streaming sub-stream A-2 320. The storage sub-stream A-1 310 includes storage segments A2, A4, and A6, and the streaming sub-stream A-2 320 includes streaming segments A1, A3, A5, and A7.

Similarly, stream B of FIG. 2 is divided into a storage sub-stream B-1 330 and a streaming sub-stream B-2 340. The storage sub-stream B-1 330 includes B2, B4, and B6, and the streaming sub-stream B-2 340 is comprised of B1, B3, and B5.

Further, stream C of FIG. 2 is divided into a storage sub-stream C-1 350 and a streaming sub-stream C-2 360. The storage sub-stream C-1 350 includes C2, and C4, and the streaming sub-stream C-2 360 includes C1, C3, and C5.

Additional information 370 is needed to recover original media streams using the storage sub-streams and the streaming sub-streams.

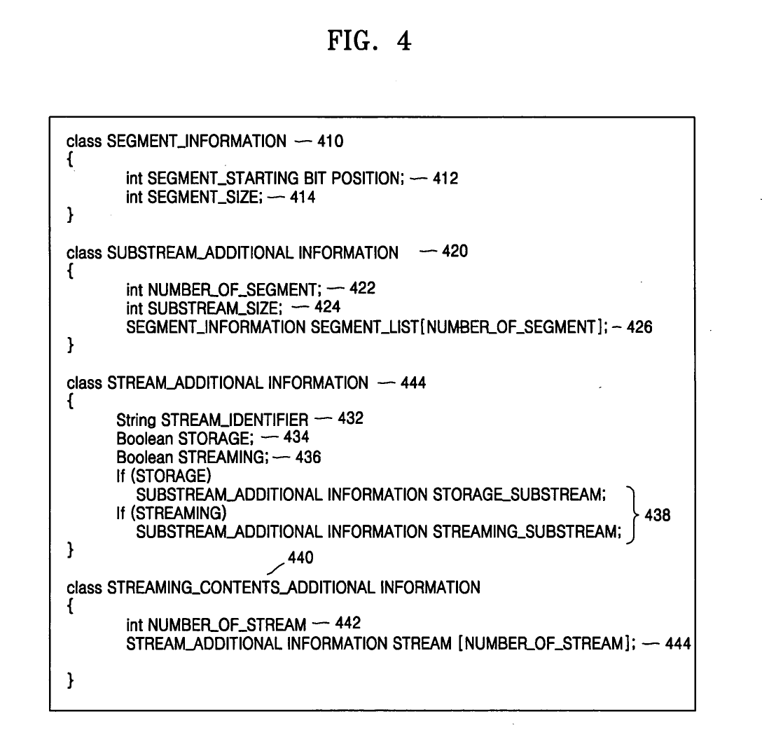

FIG. 4 shows an example of the contents of the additional information 370 of FIG. 3.

Here, it is noted that technology used to represent copyright information, metadata information, keyword information, etc., which is used in a conventional contents encoding method, can also be included in the additional information shown in FIG. 4. Accordingly, the additional information will now be described in terms of providing streaming service according to an embodiment of the present invention.

Referring to FIG. 4, “streaming_contents_additional information” 440 is information regarding multimedia contents provided by the streaming service, and is comprised of the number of streams “stream_number” 442 constituting the multimedia contents, and additional information “stream_additional information” 444 about each stream.

The “stream_additional information” 444 includes information on an identifier “stream_identifier” 432 for identifying a corresponding stream, and information about storage sub-streams 434 and streaming sub-streams 436. A stream, as a whole, can be made up of storage sub-streams or streaming sub-streams, and further includes stream additional information regarding storage sub streams or streaming sub-streams according to a Boolean value of the information about the storage sub-stream 434 or the streaming sub-stream 436, each of which is in Boolean data format.

The stream additional information regarding storage sub-streams or streaming sub-streams is recorded as “substream_additional information” 420. The “substream_additional information” 420 includes the number of segments, constituting the sub-streams “segment_count” 422, the size of sub-streams “substream_size” 424, and a list of segments “segment_list” 426. The “segment-information” 410 includes a starting position of the segments in bytes “segment_start” 412, and the size of segments “segment_size” 414.

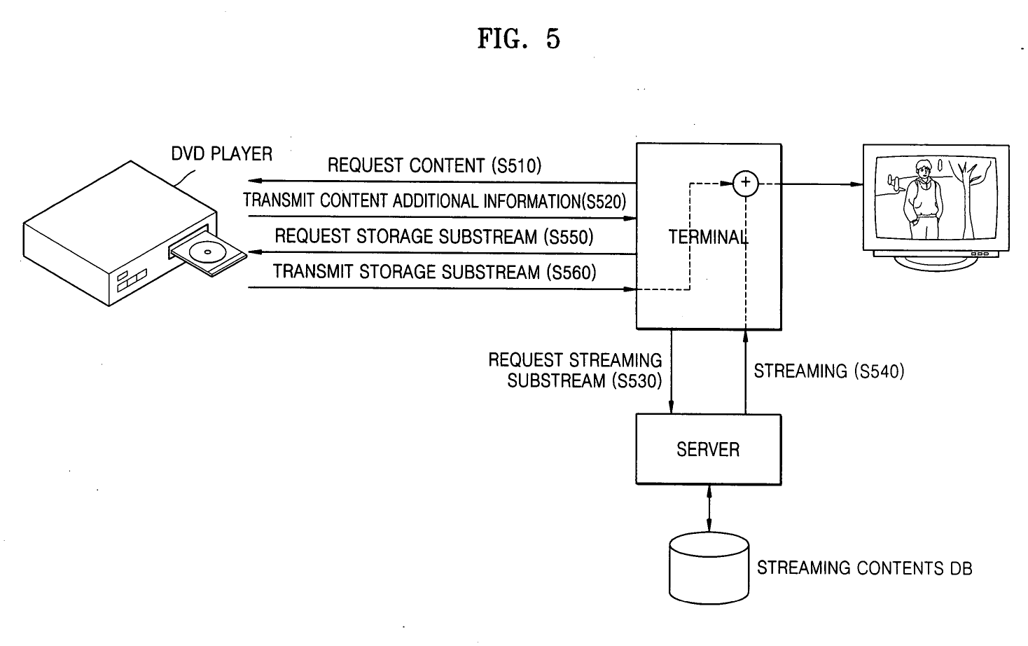

FIG. 5 is a block diagram illustrating a streaming service provided from a server to a reproducing apparatus, according to an embodiment of the present invention.

Here, conventional protocols used in authentication, session management, etc., of streaming service can also be used, however, the streaming service shown in FIG. 5 will be described according to an additional protocol of the present embodiment. The reproducing player, such as a DVD player, is coupled with a terminal, for reproducing data comprised of storage sub-streams and the additional information. The DVD player can reproduce data from a DVD having the storage sub-streams and the additional information.

First, if a content reproduction command in input by a user, the terminal communicates the command to the DVD player in operation S510. Then, the terminal reads the additional information from the DVD in operation S520. The terminal analyzes the additional information and requests a streaming service from a streaming server in operation S530. The terminal receives streaming data from the streaming server in operation S540. In addition, the terminal requests that the DVD player transmit storage sub-streams in operation S550, and receives the storage sub-streams and stores them in a storage unit in the terminal in operation S560. The terminal combines the storage sub-streams stored in the storage unit and the real-time streaming sub-streams provided by the streaming service of the server, to regenerate and reproduce original streaming contents according to the additional information.

If a media stream is encoded by a scalable coding method, only the storage sub-streams corresponding to base layer streams can be reproduced at a user's request or under the control of the network. However, if there is a request for contents of high quality, streaming sub-steams corresponding to enhancement layer streams can also be combined with the storage sub-streams, and then reproduced.

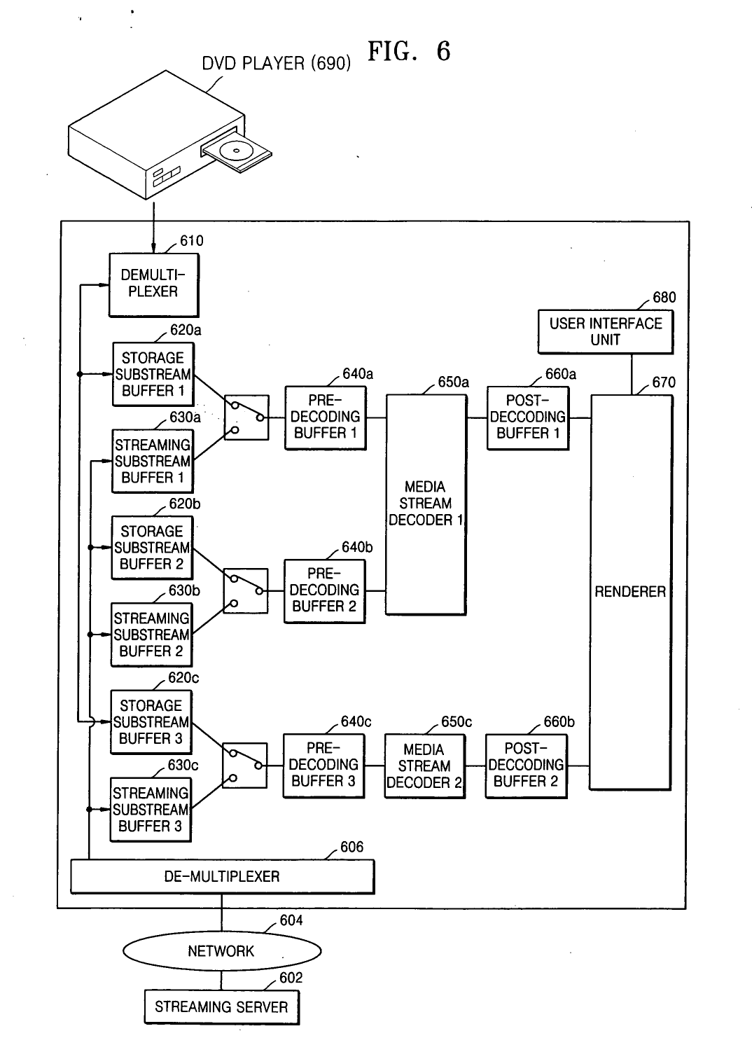

FIG. 6 is a block diagram of a reproducing apparatus according to an embodiment of the present invention.

Referring to FIG. 6, real-time streaming sub-streams transferred from a server 602 over a network 604 are split up into several streams by a de-multiplexer 606, and each of the streams is stored in a sub-stream buffers 1-3, respectively 630a, 630b, and 630c, according to information about a decoding time stamp, e.g., DTS in a MPEG-4 system, and a stream identifier, before decoding starts.

Storage sub-streams transmitted from the DVD player 690 are divided into several streams by a de-multiplexer 610, and each of the streams is stored in a corresponding sub-stream buffer 1-3, 620a, 620b, and 620c, according to information about a decoding time symbol, e.g., DTS in a MPEG-4 system, and a stream identifier, before decoding starts.

Pre-decoding buffers 1-3, 640a, 640b, and 640c, are separately reserved for all the types of streams. For a media stream, pre-decoding buffer 1 640a sequentially stores access units constituting the storage and streaming sub-streams according to the information about the DTS read from the storage sub-stream buffer 1 620a and the streaming sub-stream buffer 1 630a.

Thus, media stream decoders 650a and 650b, and a renderer 670, can operate the same way as in the conventional method/apparatus. In FIG. 6, there are 2 pre-decoding buffers 640a, and 640b needed for a media stream, which are examples for a base layer stream and an enhancement layer stream according to a scalable coding compression method.

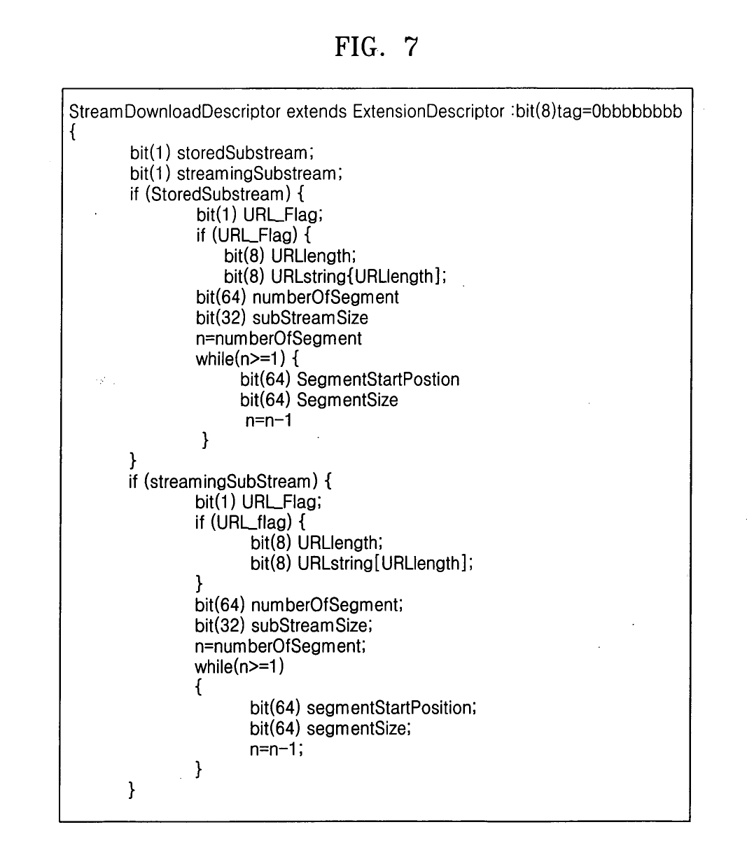

FIG. 7 is an example of additional information that is compatible with the MPEG-4 standard.

According to the MPEG-4 standard, information on a structure of contents is represented by BIFS and an object descriptor (OD), which together are referred to as an initial object descriptor (IOD). The example of FIG. 7 uses an extension descriptor included in an elementary stream descriptor for describing an MPEG-4 media stream, in order for additional information such as that shown in FIG. 4 to be compatible with conventional MPEG-4. Referring to FIG. 7, “storedSubstream” and “streamingSubstream” are information indicating whether a present media stream includes storage sub-streams or the streaming sub-streams, and each is comprised of the number of segments “numberOfSegment” divided from the storage sub-steams or the streaming sub-streams, the size of corresponding sub-streams in bytes “subStreamSize”, a starting position “SegmentStartPosition” in bytes of segments constituting the corresponding sub-stream(s), “SegmentStartPosition,” and the size of a segment “SegmentSize”. “URL_flag,” “URLlength,” and “URLstring” are used to indicate a storage location of the corresponding sub-stream(s) as a URL, according to which the terminal receives the storage sub-streams from the storage media player coupled with the terminal and the streaming sub-streams provided by the streaming server.

If compatibility with conventional MPEG-4 streams is not required, the additional information regarding a media stream may include a new descriptor that represents information as shown in FIG. 7, as well as the elementary stream descriptor used for the MPEG-4 system.

Embodiments of the present invention may be implemented as a computer program. The computer programs may be recorded on computer-readable media in order to be read and executed by computers. Such computer-readable media include all kinds of storage devices, such as magnetic storage devices, optical data storage devices, etc. The computer-readable media also include everything that is realized in the form of carrier waves, e.g., an Internet transmission.

According to the described embodiments of the present invention, multimedia data combining storage data read from a storage medium of a terminal and streaming data provided by a server can be provided efficiently.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A storage medium storing multimedia data, the multimedia data comprising:
at least one media stream that includes information about streaming data providable over a network, and storage data readable from a local storage medium by a terminal and stored in the terminal; and
additional information that includes information about how to combine the streaming data and the storage data.

2. The storage medium of claim 1, wherein the streaming data is provided by a server connected through the network and the storage data is stored in the local storage medium.

3. The storage medium of claim 1, wherein the additional information is originally recorded on the local storage medium, and includes information about a name of a file, a location, a data size, or meta-information.

4. The storage medium of claim 3, wherein the media stream includes contents additional information used to combine a first sub-stream includes the streaming data and a second sub-stream includes the storage data so as to reconstruct the media stream.

5. The storage medium of claim 4, wherein the contents additional information includes:
information about the number of media streams of the multimedia data; and
stream additional information regarding attributes of the media streams.

6. The storage medium of claim 5, wherein the stream additional information includes:
information about identifiers of the first sub-stream and the second sub-stream;
information about whether the first sub-stream or the second sub-stream is storage data or streaming data; and
information about a structure of the storage data and the streaming data.

7. A method of reproducing multimedia data in a terminal, comprising:
receiving contents additional information regarding a data structure of at least one of plural media streams of the multimedia data;
requesting storage data recorded on a local storage medium according to the contents additional information, and receiving and storing the storage data;
requesting streaming data over the network according to the contents additional information, and receiving the streaming data; and
using the storage data and the streaming data to reconstruct and reproduce an original media stream, according to the contents additional information.

8. The method of claim 7, wherein the streaming data is stored in a server storage medium connected through the network, and the storage data is stored in the local storage medium.

9. The method of claim 7, wherein the contents additional information includes: information about the number of the media streams constituting the multimedia data; and stream additional information regarding attributes of the media streams.

10. The method of claim 9, wherein the stream additional information includes:
information about identifiers of first and second sub-streams constituting a media stream;
information about whether the first sub-stream or the second sub-stream is storage data or streaming data; and
information about a structure of the storage data and the streaming data.

11. A terminal for reproducing multimedia data, comprising:
a storage sub-stream buffer that receives storage sub-streams from a local storage medium;
a streaming sub-stream buffer that receives streaming sub-streams from the streaming server over a network;
a decoder that combines the storage sub-streams and the streaming sub-streams to make a media stream and decode the media stream; and
a renderer that reproduces decoded media streams according to time syncs between the decoded media streams.

12. The terminal of claim 11, further comprising a storage sub-stream storage unit that stores the storage sub-streams and the additional information about the storage sub-streams.

13. The terminal of claim 11, further comprising a de-multiplexer that generates a plurality of streaming sub-streams from streaming data received from the streaming server.

14. The terminal of claim 11, wherein the streaming data is stored in a server storage medium connected through the network, and the storage data is stored in the local storage medium accessed by the terminal.

15. A reproducing apparatus, comprising:
a first de-multiplexer which splits streaming sub-streams into plural sub-streams;
streaming sub-stream buffers which store the split sub-streams;
a second de-multplexer which divides storage sub-streams into plural storage sub-streams;
storage sub-stream buffers which store the divided storage streams;
pre-decoding buffers for each type of stream; and
media stream decoders which combine the respective storage sub-streams and the streaming sub-streams to yield media streams and which decode the media streams.

16. The reproducing apparatus of claim 15, wherein the split streaming sub-streams are stored based on decoding time stamp information and a stream identifier.

17. The reproducing apparatus of claim 15, wherein the divided streams are stored based on decoding time symbol information and a stream identifier.

18. The reproducing apparatus of claim 15, wherein the pre-decoding buffers sequentially store access units of the storage and streaming sub-streams according to information read from the storage sub-stream buffers and the streaming sub-stream buffer.

19. The reproducing apparatus of claim 15, wherein there are two pre-decoding buffers for a base layer stream and an enhancement layer stream according to a scalable coding compression method.

20. The reproducing apparatus of claim 15, further comprising a renderer which renders the decoded media streams.

21. A method of providing streaming service from a server to a reproducing apparatus, the method comprising:
sending a content reproduction command to a DVD player when a content reproduction command in input by a user;
reading additional information from a DVD in the DVD player upon receipt of the content reproduction command;
analyzing the additional information and requesting a streaming service from a streaming server;
receiving streaming data from the streaming server;
requesting that the DVD player transmit storage sub-streams;
receiving the storage sub-streams and storing the received storage sub-streams;
receiving real-time streaming sub-streams from the server; and
combining the stored storage sub-streams and the real-time streaming sub-streams to reproduce content according to the additional information.

22. The method of claim 21, wherein the additional information is compatible with the MPEG-4 standard.

23. The method of claim 21, wherein the additional information includes a descriptor that represents information and a descriptor compatible with the MPEG-4 standard.

24. A computer-readable storage medium encoded with processing instructions for causing a processor to perform a method of reproducing multimedia data in a terminal, the method comprising:
receiving contents additional information regarding a data structure of at least one of plural media streams of the multimedia data;
requesting storage data recorded on a local storage medium according to the contents additional information, and receiving and storing the storage data;
requesting streaming data over the network according to the contents additional information, and receiving the streaming data; and
using the storage data and the streaming data to reconstruct and reproduce an original media stream, according to the contents additional information.

25. A computer-readable storage medium encoded with processing instructions for causing a processor to perform a method of providing streaming service from a server to a reproducing apparatus, the method comprising:
sending a content reproduction command to a DVD player when a content reproduction command in input by a user;
reading additional information from a DVD in the DVD player upon receipt of the content reproduction command;
analyzing the additional information and requesting a streaming service from a streaming server;
receiving streaming data from the streaming server;
requesting that the DVD player transmit storage sub-streams;
receiving the storage sub-streams and storing the received storage sub-streams;
receiving real-time streaming sub-streams from the server; and
combining the stored storage sub-streams and the real-time streaming sub-streams to reproduce content according to the additional information.
